(19) United States
(12) Patent Application Publication
(10) Pub. No.: US 2024/0346346 A1
(43) Pub. Date: Oct. 17, 2024

(54) TRANSPARENT ARTIFICIAL INTELLIGENCE FOR UNDERSTANDING DECISION-MAKING RATIONALE

(71) Applicant: VETTD, INC., Bellevue, WA (US)

(72) Inventors: Jeffrey Brennan, Bellevue, WA (US); Michael Buhmann, North Bend, WA (US); Ali Shokoufandeh, New Hope, PA (US)

(21) Appl. No.: 18/518,031

(22) Filed: Nov. 22, 2023

Related U.S. Application Data
(63) Continuation of application No. 16/600,847, filed on Oct. 14, 2019, now abandoned.
(60) Provisional application No. 62/745,186, filed on Oct. 12, 2018.

(51) Int. Cl. G06N 5/04; G06N 20/00; G06Q 10/1053

(52) U.S. Cl. CPC G06N 5/04; G06N 20/00; G06Q 10/1053

(57) ABSTRACT

A system and method provides transparency in an artificial intelligence based model. A talent data block reduces bias influencers, an algorithm block coupled to the talent data block provides time-stamped data; and a decisions block coupled to the talent data and algorithm blocks allows auditing of decisions using the time-stamped data.

### PRIORITY CLAIM

This application is a continuation of application Ser. No. 16/600,847 filed Oct. 14, 2019, which claims priority from U.S. Provisional Application No. 62/745,186 filed Oct. 12, 2018, which applications are hereby incorporated by reference in their entireties as if fully set forth herein.

### COPYRIGHT NOTICE

This disclosure is protected under United States and/or International Copyright Laws. © 2018, 2019 Vettd, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### FIELD OF THE INVENTION

This disclosure relates generally to the field of analysis using artificial intelligence and more specifically to providing transparency of the analysis.

### BACKGROUND OF THE INVENTION

The use of Artificial intelligence (AI) in important decision-making areas continues to grow and includes such important decisions as: loan-worthiness, emergency response, medical diagnosis, job candidate selection, parole determination, criminal punishment, and educator performance (see: Fast Company, “Now is the Time to Act to End Bias in AI,” Feb. 28, 2018. See https://www.fastcompany.com/40536485/now-is-the-time-to-act-to-stop-bias-in-ai.). But, a critical question keeps coming up in these areas, how are the decisions being made? What factors did AI look at and what weighting did it give these factors? These are not trivial questions given that decisions about lives and livelihood are being made based on the AI output.

The issue is typically described as the “black box” problem, the inability for people to understand exactly what machines are doing when they're teaching themselves. (See: The New York Times Magazine, “Can A.I. Be Taught to Explain Itself?”, Nov. 21, 2017, https://www.nytimes.com/2017/11/21/magazine/can-ai-be-taught-to-explain-itself.html.) Simply, data goes into the computer or cloud (the black box), AI algorithms process the data and “learn” from it, and decisions come out. The AI algorithms are changing based on what they are learning, and their output or decisions are changing as a result. But, how did the machine make that decision? With AI being used in more and more decision-making scenarios where people's lives, or livelihood are at stake, transparency into how the machine made the decisions is going to become more and more important. For example, recent changes in privacy law in the EU, require that decisions made by automated processing be explainable. Accordingly, there is a need for transparency in how the machine made the decisions.

### BRIEF DESCRIPTION OF THE DRAWINGS

Preferred and alternative examples of the present invention are described in detail below with reference to the following drawings:

FIG. 1 is a functional block diagram illustrating aspects of the present invention;

FIG. 2 is an architectural flow diagram illustrating further aspects of the present invention shown in FIG. 1; and,

FIG. 3 is a functional block diagram illustrating 0014 still further aspects of the present invention shown in FIG. 1.

### DETAILED DESCRIPTION OF THE PREFERRED EMBODIMENT

This patent application describes one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

Important issues with most Artificial Intelligence (AI) is that: 1) it requires significant amounts of data to learn (build its algorithms); 2) the algorithms themselves tend to include the biases of the developers, the trainers, and/or the data it learns from; 3) the algorithms are continuously changing as they receive additional data and feedback; and 4) there are limited means to understand how the decisions or recommendations that a particular algorithm is making is made, meaning there is little or no understanding or visibility into how the decision was arrived at by the algorithm.

Imagine you are seeking a job. You are one of a thousand applicants who turns in a resume for the position as defined in a detailed job description. The employer could engage screeners to look at all the applicant resumes and try to narrow down the number to a more reasonable number of applicants to contact and set up for interviews. They could do this by looking for specific words or phrases or positions listed in the resume that best match key attributes from the job description. The decision as to which ones make the cut is then based on the best match to the key attributes.

To save time and costs, the employer might instead digitize all of the resumes and run them through a program that looks for these same words or phrases. Again, the end result is the ones that make the cut are based on the ones with the most words (often called “key words”) or phrases that are most relevant for the position. The problem with this approach is that applicants quickly figure out that their best opportunity to make the cut is to customize each resume to the job description by including as many of the most relevant key words as possible based on the job description. Even website services have been developed that provide lists of key words to include in resumes to improve one's chances of being selected. If you are an applicant and don't include key words, your chances of making the cut are likely to decrease despite your qualifications being very relevant to the position. The result for the employer is: many people who should not be making the cut are making it, and ones that should be and are likely the best candidates, are not making it.

Now enter AI with contextual analysis into the equation. Instead of looking for key words, algorithms can be trained to look for context in the resumes that best fit a particular job position. The algorithms can be run against the resumes and develop the short list of candidates and even rank them based on relevancy according to the algorithm. One issue is the lack of transparency in the process; e.g., how or why was the ranking done the way it was? In other words, what were the factors that led to that particular sequencing of candidates. The problem to date has been a lack of transparency in how the decisions were made. The algorithm made the decisions but why those choices? Without understanding the why, one is putting faith into an algorithm. Without visibility, the questions for the employer and for the applicants are:
Was the decision made fairly?
On what basis was the decision made and at what confidence level?
Was there bias in how AI looked at the data or in the actual decision it made?
If there was bias, was it conscious, unconscious, or a combination of both?
Are the decisions being made consistent between data sets?
Are the decisions being made consistent over time?
And, on a personal level, the issue may be as simple as, why wasn't I chosen?

The European Union's new privacy law, (the General Data Protection Regulation, better known by its acronym, GDPR) came into effect in May 2018. There are several requirements that impact the ability of entities to collect large amounts of personal data and to use artificial intelligence (AI).

One significant issue is that individuals have the right not to be subject to a decision based solely on automated processing where such processing either has legal effects or significantly affects the person (GDPR Article 22). It is still early to understand the ramifications of the complete legal scope but, at a minimum, companies that are using AI that significantly impacts people are going to have to be prepared to explain how an automated process arrived at a decision: be able to explain how or why AI made the decision. This involves being able to understand the data used as well as explaining the AI algorithms that were involved in making the decision-both of which may be near impossibilities given the large amounts of data used in training AI algorithms and the ever-changing (learning) AI algorithms themselves being used in the decision-making processes. Without the ability to explain how decisions are arrived at, entities must have explicit consent to process the personal data from each user, not process individual's data who refuse to consent, and provide an alternative process, for users who request it, that allows for human intervention.

The GDPR's direct reach is the European Union's 28 countries, 500 million people, and almost fifteen trillion-dollar GDP. Its potential reach is much bigger in that it applies to all companies located in the EU despite where their customers live. For companies located outside the EU, the GDPR's reach applies to any EU citizen. Thus, the ability to use AI tools legally under the GDPR is going to be crucial. AI tools need to explain how their decisions were arrived at or companies using them can be subject to fines for non-compliance. And, these fines for not complying are significant; fines of up to 20 million euros or 4% of a company's worldwide turnover.

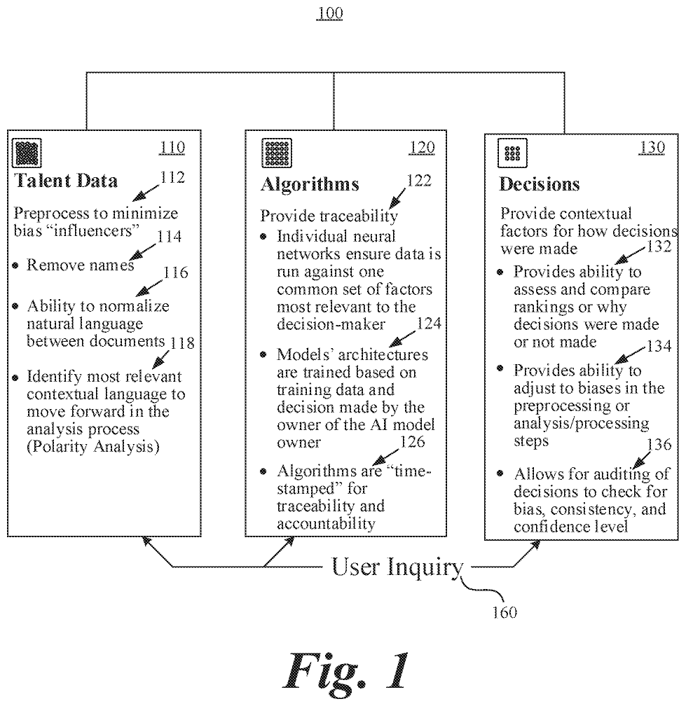

Providing a Transparent Process. A preferred embodiment of the present invention provides an approach to addressing the black box issue. It provides a system and methodology for using AI to make decision choices that are transparent and therefore, explainable. With general reference to FIGS. 1-3, an example that will be discussed is a service platform 100 that contextually analyzes data and uses AI to create neural networks for processing and providing decisions-see FIG. 1. The particular example is a talent data repository where AI is used to prioritize candidates for a particular job opportunity. Instead of the analysis being done in a black box or opaquely, the present invention exposes the choices and algorithms used at every key step so that the prioritization outcomes are explainable. The invention exposes both the choices that the AI made and the algorithms themselves. Thus, the decisions that are being made can be explained with real support materials.

The present invention provides for end-to-end transparency through the entire AI process. Transparency in data privacy involves openness; being willing to share with users all aspects of usages of their personal data. This includes an openness on what is being collected, why it is being collected, how it is being used, how it is being analyzed, and how the decisions being made by AI Algorithms were decided (what output parameters drove the decisions made by the AI algorithms).

Transparency in AI must occur during both the training of the models and the running of the models. During the training of the model the invention starts with a blank model architecture and provides visibility on what is happening as that model architecture develops the algorithms for use in decision-making based on the training data being provided. During the subsequent running of model(s), the transparency extends to include visibility or a snapshot of what the AI model is doing during its decision making, including what steps the model is taking, what is the actual algorithm itself, what intermediate decisions are being made, what parts of the model were invoked and not invoked, and what weighting factors were used to arrive at the output.

In this example, talent data will be analyzed and ranked. The talent data could be, for example, hundreds or thousands of resumes of candidates for a job. The objective of this example is to use AI to go through the talent data and identify and rank the highest potential candidates for a position(s). As shown by the example illustrated in FIG. 1, the system and methodology of platform 100 is broken into three parts: The talent data 110, the algorithms 120, and the output or decisions 130. The ability to provide end-to-end transparency is crucial to avoiding the “black box” syndrome; where data is analyzed but no one can see inside the box to understand what is going on. The three parts are discussed below along with reference to FIGS. 1-3.

Talent Data (the input)—The main component of the talent data section 110 is using contextual algorithms to provide preprocessing of the data with the main purposes of removing bias “influencers” 112 and normalizing natural language between documents 116. The objective of removing bias influencers is to reduce or eliminate language that could unduly influence the algorithms in areas of race, gender, etc. so that the algorithms are not making decisions that are influenced based on these factors. Bias influencers removed could include name, associations, organization, sports participation, or even education institutions 114. Part of the preprocessing includes normalizing natural language between documents 116. The contextual algorithms look at all of the data from all the input documents to look for differences in the language that actually are the same or have the same meaning. The idea is to change the descriptions, so they state the same thing. A simple example is where one person might list they have a JD, while another lists that they have a juris doctorate, and another lists that they received a law degree. Normalizing these differences prior to analyzing the data in the Algorithm step ensures that each person receives an equal weighting by the algorithm for that item even though they might have called it something different.

The final preprocessing step 118 is to identify the most relevant contextual language in the talent data documents. The contextual AI models analyze the data and identify which language components are most relevant to move forward to the analysis process, a process called polarity analysis. In the polarity analysis, certain portions of the data is determined to be of high value and is retained and will be used in subsequent processing; the remainder is discarded for further purposes. Critical to the transparency process, all of the preprocessing steps are visible so that the user could request, for example, to see what data was retained in the polarity analysis as being most relevant, what bias influencers were removed, and what normalization took place during this preprocessing step 112. All of these may be made visible to the user through a variety of means such as reports or via online interactions. Further, all of the talent data from the preprocessed step 112 becomes the basis for the classification and outcome of the AI models.

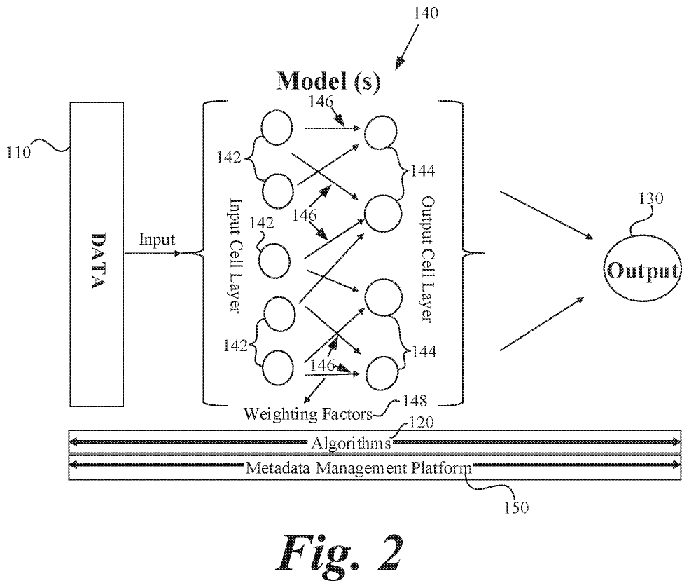

Algorithms (the analysis process) 120—The algorithms 120 control the processed data from the Talent Data 110 through neural networks that make up a model 140 to the output (see FIG. 2). In one iteration of the invention, the neural networks are trained by a decision maker or individual based on the factors most critical to that individual 122. In another iteration, feedback on most critical factors may be derived from a multitude of individuals.

To create a statistical machine learning algorithm based on artificial neural networks, an architecture must be designed and implemented in the form of cell distributions and connections among the cells. These connectivity structures determine how the data will flow 146 from input cells 142 to cells 144 in output layer. During the training phase the weights 148 of the neural network that are associated with connectivity among the cells will be determined. These training algorithms are deterministic methods and will provide the same final parameters for a given training set. The final process of designing the connectivity architecture and training the weights of the network is a learned model. During the execution phase (classification, predication, and inference), the models 140 act as a series of computational paths along the neural network structure as specified by the connectivity weights among the cells. These weighting factors 148 are not static and can be modified (retrained) over the life cycle of the network.

The system and method 100 according to a preferred embodiment of the present invention provides for transparency into all facets of the architecture. Underlying all of the processes is a metadata management system 150. Metadata is used to track the state of every key element so that the exact algorithms, weighting factors, and data can all be recreated as needed. The neural networks are time-stamped for traceability and accountability 126. Even though the neural networks may evolve over time, the metadata and timestamps allow the user to see the neural networks that were run against the data at a given point in time. While in most AI platforms, the neural networks or algorithms may be completely opaque, in this invention, the user has trace back from the decisions to the algorithms that drove the decisions at a given time in the past. Rather than an AI model in a black box, the invention provides a transparent view of the algorithms used in any given AI model that can be shown to the user through a variety of means such as reports or via online interactions, through user inquiry 160 (FIG. 1). Decisions (the output) 130. In a typical scenario, the invention will output a list of individuals with the most relevant factors in priority order based on the rankings assigned to the contextual factors by the algorithms. The entire listing is completely transparent. The user has the ability to request to see all the talent data output and can see the contextual choices that were made that drove the comparative rankings 132. This may be shown to the user through a variety of means such as reports or via online interactions. For privacy purposes, data of others users may not be shown or may be obfuscated to protect other user's identities and personal information. This list can be further analyzed for bias, consistency, and confidence level 136 when identifiers. Based on the outcomes, adjustments can be made in the preprocessing section itself to adjust for biases 134, or to provide further impact analysis, or to set up “what if’ scenarios to further analyze outcomes.

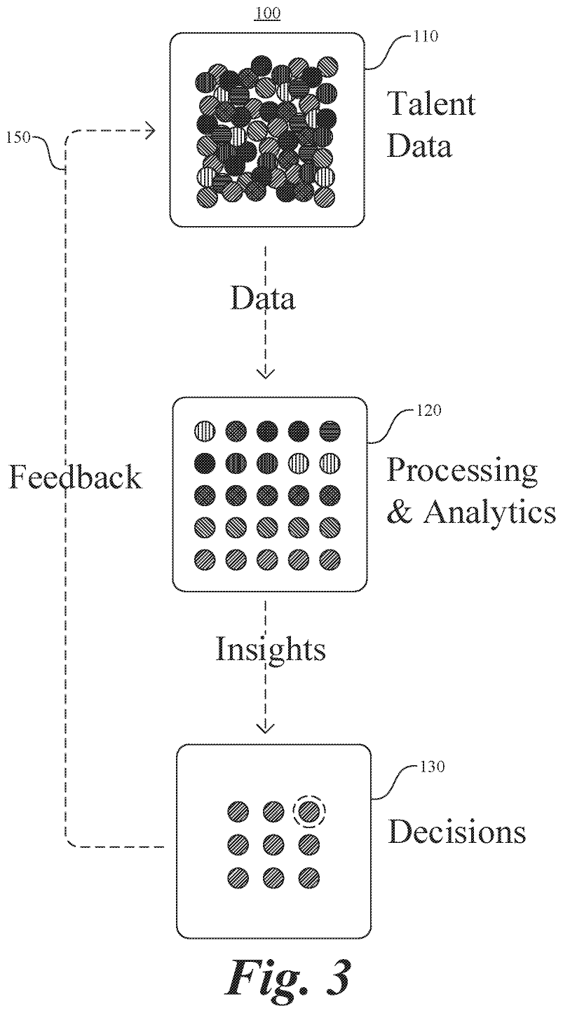

Instead of a black box with inputs and outputs and no understanding of how a decision was made, the system and method 100 of the present invention provides the basis behind the AI at each point in the decision-making process. The platform 100 captures the neural network model 140 and architecture that was used in each analysis, so users can see how ongoing neural network development is affecting decisions that impact them. The audit trail can be analyzed for biases or to adjust the neural network as needed 136 with new feedback 150 (FIG. 3) or additional factors. At all stages, the user can be provided with reasoning behind the choices made by AI. The end result is a transparent outcome, allowing all steps to be visible to users and providing accountability that the openness of the invention's AI processes provides explainability to users for the decisions made.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for providing transparency in an artificial intelligence based model comprising:
at least one processing device on which are executed:
a talent data module for reducing bias influencers by reducing textual descriptions of demographic information;
at least one neural network having time-stamped data coupled to the talent data module; and
a decisions module coupled to the talent data module and at least one neural network that allows auditing of decision using the time-stamped data.

2. A method for providing transparency in an artificial intelligence based system, comprising:
preprocessing talent data to reduce bias influencers by reducing textual descriptions of demographic information;
analyzing the preprocessed talent data and time-stamping algorithms used to analyze the preprocessed talent data; and
making decisions on analyzed talent data and providing the ability to audit the decisions based on the time stamping.
